(19) United States
(12) Patent Application Publication
(10) Pub. No.: US 2025/0097554 A1
(43) Pub. Date: Mar. 20, 2025

(54) Variable-Thickness Coils for Camera Actuators

(71) Applicant: Apple Inc., Cupertino, CA (US)

(72) Inventor: Zachary W. Birnbaum, Santa Clara, CA (US)

(21) Appl. No.: 18/369,044

(22) Filed: Sep. 15, 2023

(51) Int. Cl. H04N 23/54; G02B 7/04; G03B 3/10

(52) U.S. Cl. CPC H04N 23/54; G02B 7/04; G03B 3/10; G03B 2205/0069

(57) ABSTRACT

Embodiments of the disclosure are directed to a camera module having a lens carrier, a sensor module, and an actuator. The actuator is configured to move one or more components of the camera module, and includes a coil assembly having at least one coil. Each coil has one or more coil sections having a first cross-sectional area and one or more second coil sections having a second cross-sectional area greater than the first cross-sectional area.

### FIELD

The described embodiments relate generally to camera assemblies that may be used in electronic devices. More particularly, the present embodiments relate to camera assemblies having coils with variable thickness.

### BACKGROUND

Cameras continue to be an important feature of consumer electronics devices such as smartphones, tablets, and computers. While space is limited in consumer electronics devices, cameras in these devices have incorporated progressively larger image sensors and lens modules to improve image quality. When a camera is configured to move an image sensor and/or lens module within a camera (e.g., via an autofocus (AF) operation that adjusts the focus of the camera), moving larger optical components may place additional demands on the camera. For example, camera actuators driving such movement may require more power (and thereby lower battery life of a device incorporating the camera) and/or generate more heat (which may impact the ongoing operation of the camera). Thus, it is desirable to have power-efficient camera actuators for moving optical components in a camera.

### SUMMARY

Described herein are camera assemblies having coils with variable thickness. Certain embodiments of this disclosure are directed to a coil assembly having a carrier and a flexible printed circuit that defines a first coil that is circumferentially disposed around the carrier. The first coil includes a first pair of coil sections and a first intermediate coil section bridging the first pair of coil sections. Each coil section of the first pair of coil sections has a first cross-sectional area. The first intermediate coil section has a second cross-sectional area greater than the first cross-sectional area.

Other embodiments of this disclosure are directed to a camera module having a lens carrier, a set of lens elements carried by the lens carrier, a plurality of magnets, and a coil positioned around the lens carrier. The coil includes a plurality of first coil sections and a plurality of second coil sections. Each first coil section has a first cross-sectional area and is positioned adjacent to a corresponding magnet of the plurality of magnets. Each second coil section has a second cross-sectional area greater than the first cross-sectional area and transitions between a pair of consecutive first coil sections.

Still other embodiments are directed to a camera module having a lens carrier, a sensor module, and an actuator. The lens carrier has a lens module with an optical axis. The sensor module includes an image sensor positioned to receive light from the lens module. The actuator is configured to move the lens carrier relative to the image sensor along the optical axis. The actuator includes a set of magnets and a coil comprising a set of first coil sections and a set of second coil sections. Each first coil section has a first cross-sectional area and is positioned adjacent to a corresponding magnet of the set of magnets. Each second coil section has a second cross-sectional area greater than the first cross-sectional area.

In addition to the example aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A illustrates a device as described herein having a camera actuator that includes a coil assembly with variable thickness, according to certain aspects of the present disclosure;

FIG. 1B depicts exemplary components of the device of FIG. 1A, according to certain aspects of the present disclosure;

FIG. 2A shows a perspective view of a first example camera module having coils with variable thickness, according to certain aspects of the present disclosure;

FIG. 2B shows an exploded perspective view of the first example camera module of FIG. 2A, according to certain aspects of the present disclosure;

FIG. 2C shows a perspective view of an actuator with coils of variable thickness in the first example camera module of FIG. 2A, according to certain aspects of the present disclosure;

FIG. 2D shows a top view of the actuator of FIG. 2C, according to certain aspects of the present disclosure;

FIG. 3A shows a cross-sectional side view of a flexible printed circuit that defines multiple coils;

FIG. 3B shows a top view of a coil of the flexible printed circuit of FIG. 3A in a flat state;

FIG. 3C shows a top view of a variation of a flexible printed circuit that defines a coil as described herein;

FIG. 4A shows a perspective view of a second example camera module having coils with variable thickness, according to certain aspects of the present disclosure; and

FIG. 4B shows an exploded perspective view of the second example camera module of FIG. 4A, according to certain aspects of the present disclosure.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claim.

Directional terminology, such as “top,” “bottom,” “upper,” “lower,” “front,” “back,” “over,” “under,” “above,” “below,” “left,” “right,” “vertical,” “horizontal,” etc. is used with reference to the orientation of some of the components in some of the figures described below, and is not intended to be limiting. Because components in various embodiments can be positioned in a number of different orientations, directional terminology is used for purposes of illustration to demonstrate the relative orientation between components of the systems and devices described herein. The directional terminology is intended to be construed broadly, and therefore should not be interpreted to preclude components being oriented in different ways.

Embodiments of the disclosure are directed to camera assemblies for use in electronic devices (e.g., smartphones, tablet computers, etc.) and more particularly, to camera assemblies having coils with variable thickness. Specifically, a camera module as described herein includes a coil assembly, where the coil assembly includes one or more coils with a cross-sectional area that varies along a length of the coil. For example, each coil may include a set of first coil sections having a first thickness alternating with a set of second coil sections having a second thickness greater than the first thickness. Such a coil assembly may be incorporated into an actuator that is configured to move an optical component (e.g., a lens module or an image sensor) within a camera module, and may facilitate power-efficient operation of the actuator.

When a coil assembly as described herein is incorporated into an actuator having a set of magnets, some or all of the first coil sections may be positioned adjacent to a corresponding magnet of the set of magnets. When current is driven through the coil(s) of the coil assembly (e.g., received from a driver), a Lorentz force may be generated between the coil assembly and the set of magnets. This Lorentz force may be used to create relative movement between the coil assembly and the set of magnets, which in turn may be used to provide relative movement of optical components of a camera module (e.g., relative movement between an image sensor and a lens module) The relatively smaller cross-sectional area of the first coil sections focuses the received current near the centers of the corresponding magnets (where the magnetic fields provided by the magnets may be strongest and most uniform), which improve the magnitude and linearity of the generated Lorentz force.

Conversely, the second coil sections may not be positioned adjacent the set of magnets, such that second coil sections do not meaningfully contribute to the Lorentz force generated between coil assembly and the set of magnets. The relatively larger cross-sectional area of the second coil sections reduces the resistance to current flow through each second coil section (as compared to the first coil sections). This may reduce the overall resistance of the coil(s) of the coil assembly, which may reduce the power consumed by operating the actuator (or increase the number of turns of the coil(s) through which current may be driven for a given power budget).

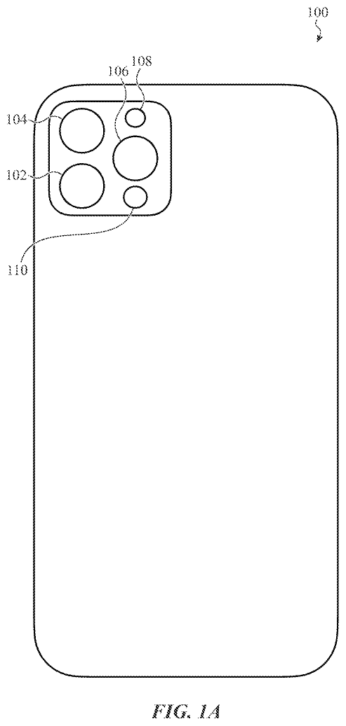

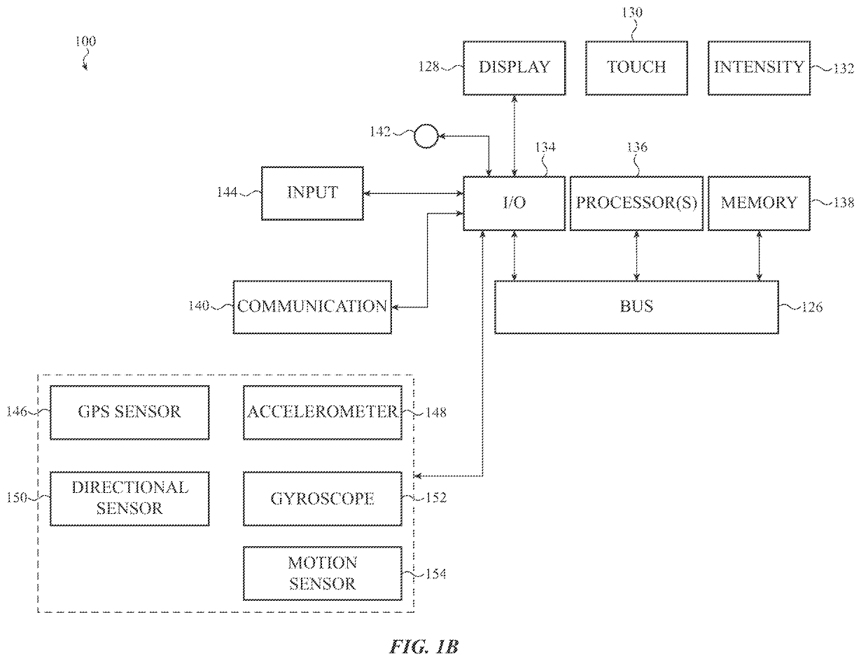

These and other structural and functional features are discussed below through embodiments in FIGS. 1A-4B. However, those skilled in the art will readily appreciate that the detailed description given herein with respect to these Figures is for explanatory purposes only and should not be construed as limiting.

FIG. 1A depicts an example device 100 as described herein. As shown there, the device 100 includes a multi-camera system. For example, in the variation shown in FIG. 1A, the device 100 includes a first camera 102, a second camera 104, and a third camera 106. One or more of the first camera 102, the second camera 104, and the third camera 106 may include a coil assembly as described herein. The coil assembly allows an actuator in one or more of the first camera 102, the second camera 104, and the third camera 106 to operate with improved efficiency. It should be appreciated that the device 100 may include a single camera, or a multi-camera system having any number of cameras (with any relative positioning) as may be desired. Additionally, while shown as placed on the rear of a device 100, it should be appreciated that a camera having a coil assembly as described herein may be additionally or alternatively placed on the front (e.g., a front side having a display) or any other side of the device as desired.

In some embodiments, the device 100 may include a flash module 108. The flash module 108 may provide illumination to some or all of the fields of view of the cameras of the device (e.g., the fields of view of the first camera 102, the second camera 104, and/or the third camera 106). This may assist with image capture operations in low light settings. Additionally, or alternatively, the device 100 may further include a depth sensor 110 that may calculate depth information for a portion of the environment around the device 100. Specifically, the depth sensor 110 may calculate depth information within a field of coverage (i.e., the widest lateral extent to which the depth sensor is capable of providing depth information). The field of coverage of the depth sensor 110 may at least partially overlap the field of view of one or more of the cameras (e.g., the fields of view of the first camera 102, second camera 104, and/or third camera 106). The depth sensor 110 may be any suitable system that is capable of calculating the distance between the depth sensor 110 and various points in the environment around the device 100.

The depth information may be calculated in any suitable manner. In one non-limiting example, a depth sensor may utilize stereo imaging, in which two images are taken from different positions, and the distance (disparity) between corresponding pixels in the two images may be used to calculate depth information. In another example, a depth sensor may utilize structured light imaging, whereby the depth sensor may image a scene while projecting a known pattern (typically using infrared illumination) toward the scene, and then may look at how the pattern is distorted by the scene to calculate depth information. In still another example, a depth sensor may utilize time of flight sensing, which calculates depth based on the amount of time it takes for light (typically infrared) emitted from the depth sensor to return from the scene. A time-of-flight depth sensor may utilize direct time of flight or indirect time of flight, and may illuminate an entire field of coverage at one time, or may only illuminate a subset of the field of coverage at a given time (e.g., via one or more spots, stripes, or other patterns that may either be fixed or may be scanned across the field of coverage). In embodiments where a depth sensor utilizes infrared illumination, this infrared illumination may be utilized in a range of ambient conditions without being perceived by a user.

In some embodiments, the device 100 is a portable multifunction electronic device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer, which may have a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content by transmitting, via a wired or wireless connection, data (e.g., image data or video data) to an integrated or external display generation component to visually produce the content.

FIG. 1B depicts exemplary components of the device 100. In some embodiments, device 100 has a bus 126 that operatively couples an I/O section 134 with one or more computer processors 136 and memory 138. The I/O section 134 can be connected to display 128, which can have touch-sensitive component 130 and, optionally, intensity sensor 132 (e.g., contact intensity sensor). In addition, I/O section 134 can be connected with communication unit 140 for receiving application and operating system data, using Wi-Fi, Bluetooth, near field communication (NFC), cellular, and/or other wireless communication techniques. The device 100 can include input mechanisms 142 and/or 144. Input mechanism 142 is, optionally, a rotatable input device or a depressible and rotatable input device, for example. Input mechanism 142 is, optionally, a button, in some examples. The device 100 optionally includes various sensors, such as GPS sensor 146, accelerometer 148, directional sensor 150 (e.g., compass), gyroscope 152, motion sensor 154, and/or a combination thereof, all of which can be operatively connected to I/O section 134. Some of these sensors, such as accelerometer 148 and gyroscope 152 may assist in determining an orientation of the device 100 or a portion thereof.

Memory 138 of the device 100 can include one or more non-transitory computer-readable storage mediums, for storing computer-executable instructions, which, when executed by one or more computer processors 136, for example, can cause the computer processors to perform the techniques that are described here (such as operation of the example actuators described herein). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

The processor 136 can include, for example, dedicated hardware as defined herein, a computing device as defined herein, a processor, a microprocessor, a programmable logic array (PLA), a programmable array logic (PAL), a generic array logic (GAL), a complex programmable logic device (CPLD), an application-specific integrated circuit (ASIC), a field-programmable gate array (FPGA), or any other programmable logic device (PLD) configurable to execute an operating system and applications of device 100, as well as to facilitate capturing of images as described herein. Device 100 is not limited to the components and configuration of FIG. 1B, but can include other or additional components in multiple configurations.

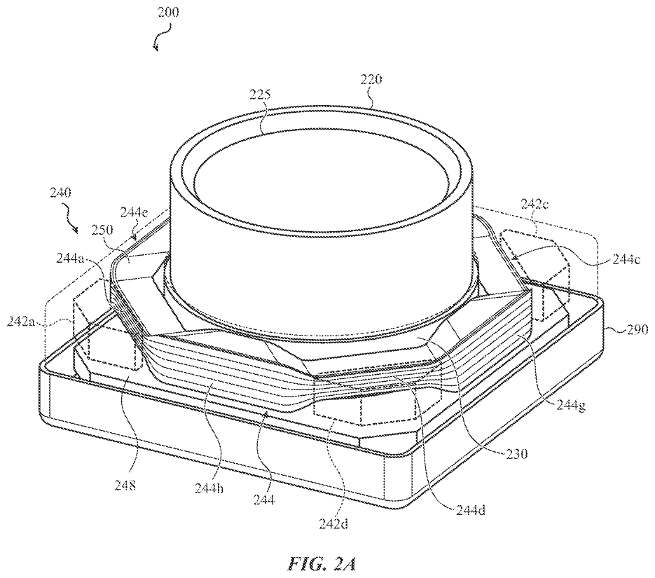

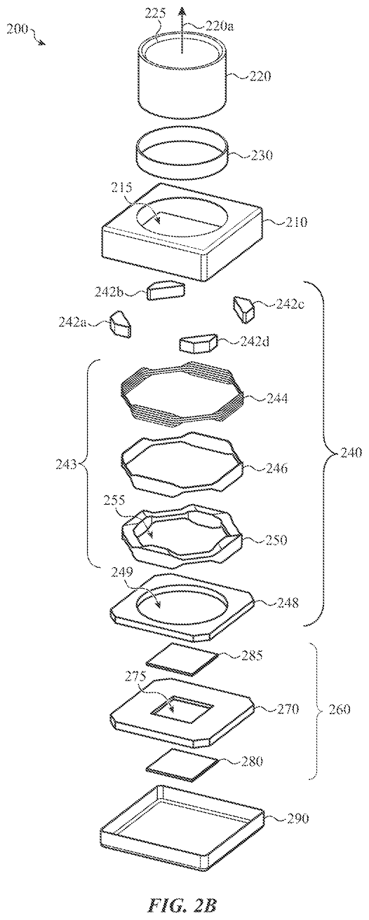

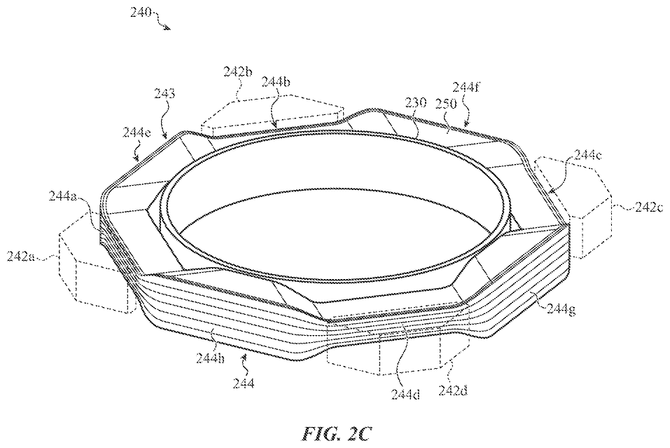

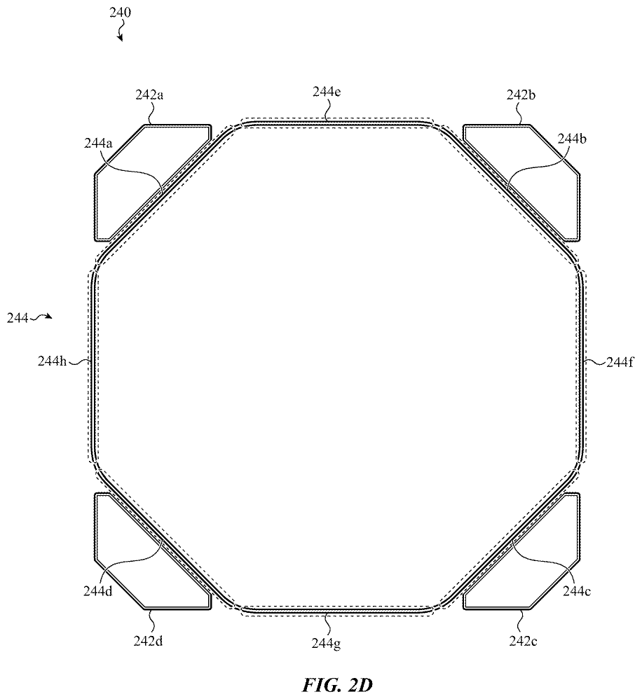

FIGS. 2A-2B show a perspective view and an exploded perspective view of a camera module 200 having coils with variable thickness. The camera module 200 includes an upper housing 210 and a lower housing 290 that together form an enclosure for housing various components of the camera module 200. The upper housing 210 and the lower housing 290 may be formed from a metal and function as a shield (e.g., to shield against electromagnetic interference). In some non-limiting embodiments, as shown in FIGS. 2A-2B, the upper housing 210 and the lower housing 290 together form an enclosure having a cuboidal shape, though it should be appreciated that the enclosure may be formed with any suitable shape as may be desired.

The camera module 200 may include a lens module 220, a portion of which may protrude outward through an opening 215 defined to extend through the upper housing 210. The lens module 220 includes one or more lens elements disposed along an optical axis 220a. The one or more lens elements may be arranged to receive light through an aperture 225 of the lens module 220. The lens module 220 may include a lens barrel that houses and holds various optical elements of the corresponding lens module (e.g., lens elements, aperture layers, filters or the like). In some embodiments, the lens barrel of the lens module 220 may serve to hold some or all of the optical elements in a fixed relationship.

In the variation shown in FIGS. 2A and 2B, the lens module 220 is moveable along the optical axis 220a relative to an image sensor 280 to provide autofocus (AF) functionality to the camera module 200. Specifically, an actuator 240 may be connected to the lens module 220 and configured to move the lens module 220 vertically along the optical axis 220a, which may focus light captured by the lens module 220 onto an image sensor module 260. The actuator 240 includes a set of magnets 242a-242d and a coil assembly 243. One or more suspension elements (not shown), such as a sheet spring, flexure, or the like, may moveably connect the coil assembly 243 to another location (or locations) of the camera module 200 (e.g., a portion of the upper housing 210, or another component mounted thereto), which allows the actuator 240 to controllably move the lens module 220 relative to these locations. The actuator 240 may further include an actuator base 248 to which the set of magnets 242a-242d may be mounted. The actuator base 248 may include a channel 249 through which light received by the lens module 220 passes to the image sensor module 260.

The image sensor module 260 includes a substrate 270 (e.g., positioned within the lower housing 290) and an image sensor 280 coupled thereto. The substrate 270 may route electrical signals and provide mechanical support to the image sensor 280. In some instances, the image sensor 280 is coupled to a bottom surface of the substrate 270, and the substrate 270 includes an opening 275 through which light received by the lens module 220 passes to the image sensor module 260. Additionally, an infrared filter 285 may be positioned between the lens module 220 and the image sensor 280 (e.g., coupled to a top surface of the substrate 270), such that light received by the image sensor 280 first passes through the infrared filter 285. The image sensor module 260 may also include a flexible printed circuit (not shown) electrically coupled to the substrate 270 and/or the image sensor 280. The flexible printed circuit may extend externally from the camera module 200 to route power, control, and/or other signals (e.g., image data) therefrom and/or thereto.

The coil assembly 243 includes a carrier 250 and at least one coil. A single coil 244 is shown in FIGS. 2A and 2B, though it should be appreciated that the coil assembly 243 may alternatively include two or more coils. Each coil of the coil assembly 243 may be circumferentially disposed around the carrier 250. The coil assembly 243 may further include an insulating layer 246 disposed between the carrier 250 and the coil 244.

The actuator 240 is configured such that the coil 244 (as well as any other coils of the coil assembly 243) is at least partially positioned within the magnetic fields generated by the set of magnets 242a-242d. To operate the actuator 240, current may be driven through coil 244 (or multiple coils of the coil assembly 243), which may generate a Lorentz force between the coil assembly 243 and the set of magnets 242a-242d. This Lorentz force causes the coil assembly 243 and thereby the lens module 220 to move vertically along the optical axis 220a, thereby providing autofocus (AF) functionality.

In these variations, the carrier 250 acts as a lens carrier to hold the lens module 220. Specifically, the lens module 220 may be coupled to the carrier 250, such that the lens module 220 moves with the carrier 250. For example, the lens module 220 may be coupled to the carrier 250 using a bonding agent 230 (e.g., an adhesive). The carrier 250 includes a channel 255 extending therethrough for accommodating the lens module 220 (e.g., the lens module 220 may be positioned to extend at least partially through the channel 255). In these instances, the coil assembly 243 may be circumferentially disposed around both the carrier 250 and the lens module 220.

While the actuator 240 of FIGS. 2A to 2B is configured to move a lens module 220 along the optical axis 220a, it should be appreciated that the coil assemblies described herein may be used in a wide range of actuators. For example, in other variations, the actuator 240 may be configured to move the image sensor 280 relative to the lens module 220 in order to provide autofocus (AF) functionality (e.g., the coil assembly 243 may be instead connected to the image sensor 280 such that the image sensor 280 moves with the coil assembly 243). The actuator 240 may additionally or alternatively be configured to generate lateral relative movement (e.g., perpendicular to the optical axis 220a) between the lens module 220 and the image sensor 280 to provide optical image stabilization capabilities to the camera module 200.

The coil 244 includes a set of first coil sections each having a first cross-sectional area and a set of second coil sections each having a second cross-sectional area that is larger than the first cross-sectional area. As used herein, the “cross-sectional area” of a coil section (or an individual turn thereof) refers to the area of that coil section in a plane that is perpendicular to the direction that current flows through the coil. In some instances, the coil 244 includes a plurality of first coil sections and a plurality of second coil sections.

For example, FIGS. 2C and 2D show a perspective view and a top view of the actuator 240 of the camera module 200. As shown there, the coil 244 includes a plurality of first coil sections 244a-244d each having a corresponding first cross-sectional area and a plurality of second coil sections 244e-244h each having a corresponding second cross-sectional area. The cross-sectional area of each of the plurality of first coil sections 244a-244d is less than the cross-sectional area of each of the plurality of second coil sections 244e-244h. In some variations, the cross-sectional area of each of the second coil sections 244e-244h may be at least twice the cross-sectional area of each of the first coil sections 244a-244d. While each of the plurality of first coil sections 244a-244d is shown in FIGS. 2C and 2D as having the same cross-sectional area, it should be appreciated that different first coil sections may have different cross-sectional areas. Similarly, while each of the plurality of second coil sections 244e-244h is shown in FIGS. 2C and 2D as having the same cross-sectional area, it should be appreciated that different second coil sections may have different cross-sectional areas.

Each of the second coil sections 244e-244h may act as an intermediate coil section to bridge a pair of consecutive first coil sections 244a-244d, such that the cross-sectional area of the coil 244 transitions to a larger cross-sectional area between the pair of first coil sections. For example, as shown in FIGS. 2C and 2D, second coil section 244e is positioned between first coil section 244a and 244b to connect these first coil sections. In this way, the cross-sectional area of the coil 244 may increase as the first coil section 244a transitions to the second coil section 244e and then decrease as the second coil section 244e transitions to the first coil section 244b. Similarly, second coil section 244f bridges first coil sections 244b and 244c, and so on.

Each of first coil sections 244a-244d may be positioned adjacent to a corresponding magnet of the set of magnets 242a-242d. In this way, each first coil section may be positioned in the magnetic field of a corresponding magnet. For example, in the variation shown in FIGS. 2C and 2D, first coil section 244a is positioned within the magnetic field of a first magnet 242a, first coil section 244b is positioned within the magnetic field of a second magnet 242b, first coil section 244c is positioned within the magnetic field of a third magnet 242c, and first coil section 244d is positioned within the magnetic field of a fourth magnet 242d. While shown as having four magnets and four first coil sections, it should be appreciated that the actuator 240 may include more or fewer magnets and/or first coil sections. Additionally, while the set of magnets 242a-242d are shown in FIGS. 2A-2D as having trapezoidal cross-sectional shapes that are positioned at the corners of the enclosure, it should be appreciated that the set of magnets 242a-242d may have any suitable size, shape, and positioning as may be desired. It should be appreciated that a magnet having a trapezoidal cross-sectional shape, it should be appreciated that one or more edges of the magnet may be rounded, chamfered, or otherwise shaped to provide a more gradual transition between sides of the magnet.

The cross-sectional area of the coil 244 may vary in any suitable manner as the coil transitions between a first coil section and a second coil section. Specifically, the coil 244 (as well as any individual turns thereof) may have a length that wraps circumferentially around the carrier 250, a first thickness in a direction parallel to the optical axis 220a (referred to herein as the “height”) and a second thickness (referred to herein as the “width”) perpendicular to the height and length. In some of these variations, the turns of the coil 244 may each have a rectangular cross-sectional shape having a height and width, and collectively define the cross-sectional areas of the first and second coil sections. Accordingly, the height and/or width of the individual turns may vary along their length to change the overall cross-sectional area between the different coil sections.

The height and/or width of the coil 244 may vary between adjacent coil sections. For example, in some variations the height of the coil 244 may change between the first coil sections 244a-244d and the second coil sections 244e-244h. Specifically, the height of each second coil section may greater than a height of each first coil section. For example, in some variations the height of each of the second coil sections 244e-244h may be at least twice the height of the first coil sections 244a-244d. In some of these variations, a width of each of the second coil sections 244e-244h may be the same as a width of each of the first coil sections 244a-244d. In others of these variations, a width of each of the second coils sections 244e-244h may be greater than the width of each of the first coil sections 244a-244d. In still other variations, the width of each of the second coils sections 244e-244h may be greater than the width of each of the first coil sections 244a-244d, while the height of each of the second coils sections 244e-244h may be the same as the height of each of the first coil sections 244a-244d.

The height and/or width of the coil 244 may have different dimensions relative to one or more other components of the camera module 200. For example, in some variations the height of each of the second coil sections 244e-244h may be greater than or equal to a height of each of the set of magnets 242a-242d. Conversely, the height of each of the first coil sections 244a-244d may be less than the heights of the set of magnets 242a-242d.

As mentioned previously, each of the first coil sections 244a-244d may be positioned adjacent to (e.g., facing) and in the magnetic field of a corresponding magnet of the set of magnets 242a-242d. The actuator 240 may be configured such that, when the actuator 240 is in a neutral position (e.g., is not actively being driven to move the coil assembly 243 relative to the set of magnets 242a-242d), each of the first coil sections 244a-244d may be aligned, along the optical axis 220a, with a center of a corresponding magnet of the set of magnets 242a-242d. This may position the first coil sections 244a-244d where the magnetic fields of the set of magnets 242a-242d are strongest, and may, along with the relatively smaller cross-sectional area of first coil sections 244a-244d, improve the magnitude and linearity of the generated Lorentz forces when current is driven through the coil 244. Conversely, the second coil sections 244e-244h are positioned such that they do not face the magnets of the set of magnets 242a-242d, and do not significantly interact with the magnetic fields of these magnets. Accordingly, the second coil sections 244e-244h do not significantly contribute to the Lorentz forces generated when current is driven through the coil 244. As a result, the relatively larger cross-sectional area of the second coil sections 244e-244h may reduce the overall resistance of the coil 244 without significantly impacting the Lorentz force generated when current is driven through the coil 244.

The carrier 250 may provide mechanical support for the coil 244. In some variations, the carrier 250 may be shaped to accommodate the coil assembly 243 along contours thereof. For example, a height of the carrier 250 may vary with the height of the coil 244. As shown in FIGS. 2A-2C, the height of the carrier 250 may be larger in areas supporting the second coil sections 244e-244h than in areas supporting the first coil sections 244a-244d.

In some variations, the coil assemblies described herein may include coils formed from a flexible printed circuit. For example, in some variations, the coil 244 and insulating layer 246 of the coil assembly 243 of FIGS. 2A-2D may be formed as part of a flexible printed circuit. In the variations, the coil or coils may be formed from one or more traces made of a conductive material (e.g., copper) that is formed on a flexible insulating substrate (e.g., polyimide) as part of a flexible printed circuit. Once formed, the flexible printed circuit may be wrapped around a carrier (e.g., carrier 250) to position the coil around the carrier.

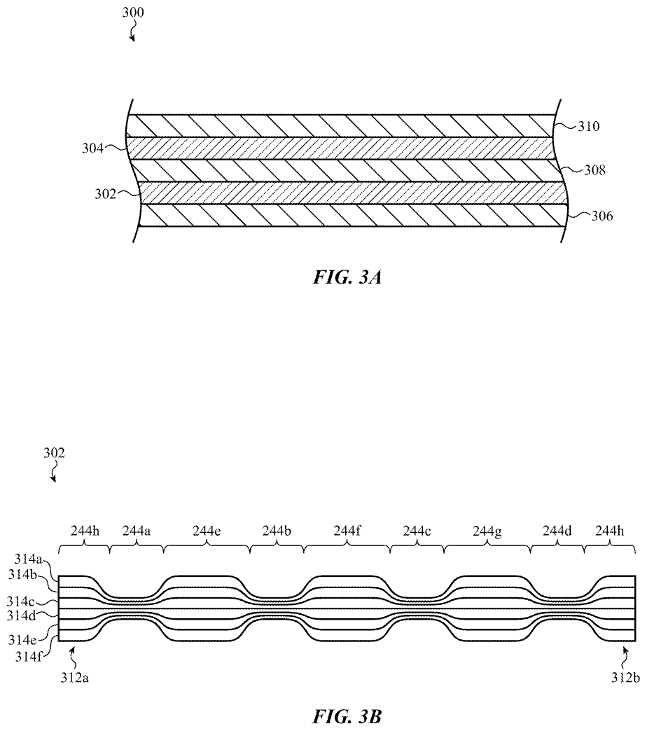

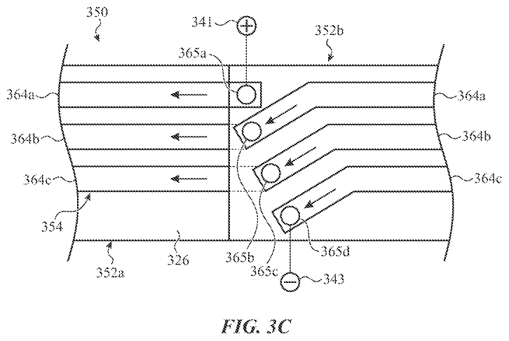

In some variations, a coil assembly as described herein may include two or more coils that may be concentrically positioned around a carrier (e.g., carrier 250). In some of these variations, each coil may be formed from a separate flexible printed circuit, and the flexible printed circuits may be stacked and wrapped around a carrier as discussed previously. In other variations, multiple coils may be formed of different layers of a single flexible printed circuit. For example, FIG. 3A shows a cross-sectional side view of a flexible printed circuit 300 that defines a first coil 302 and a second coil 304. Specifically, the first coil 302 may be formed on a first insulating layer 306, and a second insulating layer 308 may be formed on the first coil 302. The second coil 304 may be formed on the second insulating layer 308, such that the second insulating layer 308 electrically insulates first coil 302 from the second coil 304. It should be appreciated that portions of the first coil 302 and the second coil 304 may be electrically connected, if so desired, using one or more conductive vias that pass through the second insulating layer 308. In some variations, a third insulating layer 310 may be formed on the second coil 304 to provide further insulation to the second coil 304.

The first coil 302 and the second coil 304 may be configured to have the same shape. For example, each of the first and second coils 302, 304 may include a set of first coil sections and a second of second coil sections, such as described herein with respect to FIGS. 2A-2D. The first coil sections of the first coil 302 may overlap the corresponding first coil sections of the second coil 304, and the second coil sections of the first coil 302 may overlap the second coil sections of the second coil 304. For example, FIG. 3B shows a top view of the second coil 302. As shown there, the first coil 302 is shaped to include the plurality of first coil sections 244a-244d and the plurality of second coil sections 244e-244h of coil 244. In example shown in FIG. 3B, the second coil section 244h is split into two portions (one at a first end 312a of the flexible printed circuit 300 and one at an opposite second end 312b of the flexible printed circuit 300), which allows the flexible printed circuit 300 to be formed in a flat configuration and later be wrapped around a carrier. It should be appreciated that this split may occur within any coil section of the first coil 302, or alternatively between two consecutive coil sections (e.g., between first coil section 244a and second coil section 244e of the first coil 302).

In some variations, each coil of the coil assembly may include one or more turns. As used herein, a “turn” of a coil refers to an individual current path through which current may flow around a carrier supporting the coil, and may represent the number of times that the current completes a loop around the carrier. For example, the first coil 302 of the flexible printed circuit 300 of FIGS. 3A-3B is shown as having a plurality of turns 314a-314f (each representing a different trace formed on the first insulating layer 306). When current is driven through the first coil 302, current may flow separately through each of the plurality of turns 314a-314f to complete a loop around a carrier. While shown in FIGS. 3A-3B as having six turns defined by six traces, the first coil 302 may alternatively have more or fewer turns.

When a coil is formed with multiple traces as part of a flexible printed circuit, such as the first coil 302 or the second coil 304, current may be driven through the traces in series, such that turn is formed by a corresponding trace of the coil. For example, FIG. 3C shows a variation of flexible printed circuit 350 that has a coil 354 and an insulating layer 326, where the coil 354 includes a plurality of turns 364a-364c that are driven in series. While each of the turns 364a-364c is shown in FIG. 3C as being formed from a separate trace of the coil 354, it should be appreciated that any given turn may be formed from multiple traces that are electrically connected in parallel, if so desired.

To drive the plurality of turns 364a-364c, certain turns at a first end 352a of the flexible printed circuit 350 are electrically connected to different turns at a second end of 352b of the flexible printed circuit 350. For example, a first end of a first turn 364a may be connected to a first terminal 341 at a first end 352a of the flexible printed circuit 350, and a second end of the first turn 364a may be connected to a second turn 364b at a second end 352b of the flexible printed circuit 350. Similarly, the second turn 364b is connected (at a first end thereof) to the first turn 364a at the first end of the first end 352a of the flexible printed circuit 350, and is connected (at a second end thereof) to a third turn 364c at the second end 352b of the flexible printed circuit 350. The third turn 364c is connected to the second turn 364b at the first end 352a of the flexible printed circuit 350 and is connected to a second terminal 343 at the second end 352b of the flexible printed circuit 350. When a driver (not shown) applies a voltage across the first and second terminals 341, 343, current is driven through the plurality of turns 364a-364c in series. Specifically, current flows from the first terminal 341 through the first turn 364a, then flows from the first turn 364a into the second turn 364b. After flowing through the second turn 364b, current then flows from the second turn 364b to the third turn 364c, and then to the second terminal 343.

The connections between different turns may be accomplished in any suitable manner. For example, in the variation shown in FIG. 3C, when the flexible printed circuit 350 is incorporated into a coil assembly (e.g., wrapped around a carrier such as carrier 250), the flexible printed circuit 350 may be configured such that a portion of the first end 352a overlaps with a portion of the second end 352b. In these instances, conductive vias may connect different turns. For example, a first conductive via 365a may extend through one or more conductive layers of the flexible printed circuit 350 to allow electrical connection between the first turn 364a and the first terminal 341. Similarly, a second conductive via 365b may connect the first turn 364a to the second turn 364b, a third conductive via 365c may connect the second turn 364b to the third turn 364c, and a fourth conductive via may connect the third turn 364c to the second terminal 343. In other variations, the first and second ends 352a, 352b of the flexible printed circuit 350 may not overlap, and an additional component or components (e.g., including a set of conductive traces) may bridge a gap between the ends of the flexible printed circuit 350 to provide electrical connections between the different turns.

When a coil assembly as described herein includes multiple coils, these coils may be individually controlled or may be electrically connected to each other such that they are controlled together. For example, each coil may be separately connected to a corresponding pair of terminals (e.g., a first coil is connected to a first set of terminals that is electrically isolated from a second set of terminals connected to the second coil), such that a driver (e.g., an electrical supply thereof) may selectively drive current through only one coil or both coils simultaneously as may be desired. In other variations, multiple coils may be electrically connected to the same set of terminals (e.g., in parallel or in series).

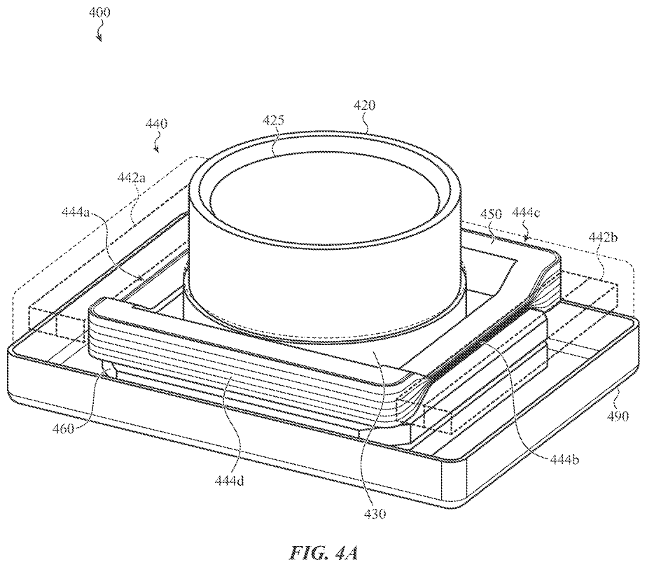

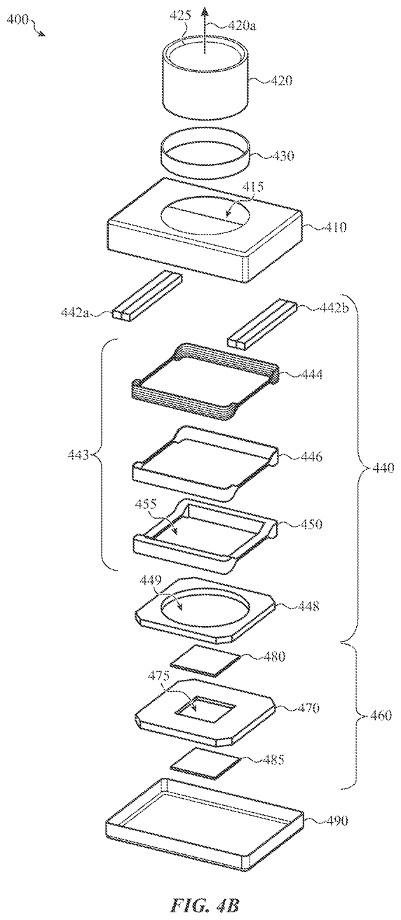

FIGS. 4A and 4B show a perspective view and an exploded perspective view, respectively, of another camera module 400 having a coil assembly 443 with a coil 444 (or multiple coils) with variable thickness. The camera module 400 includes an upper housing 410 (defining an opening extending therethrough) and a lower housing 490 that form an enclosure, a lens module 420 having an aperture 425, and an image sensor module 460 that includes an image sensor 485, a substrate 470, and an infrared filter 480. The components may be configured in any suitable manner as described above with respect to the corresponding components of the camera module 200 of FIGS. 2A and 2B.

The camera module 400 also includes an actuator 440 that includes the coil assembly 443 (which further includes a carrier 450 connected to the lens module 420 via a bonding agent 430 and an insulating layer 446 positioned between the coil 444 and the carrier 450), a set of magnets 442a-442b, an actuator base 448 defining an opening 449 extending therethrough, and one or more suspension elements (not shown). The actuator 440 may be configured the same as the actuator 240 of FIGS. 2A-2D, except that the set of magnets 442a-442b includes two magnets (e.g., a first magnet 442a and a second magnet 442b) instead of the four magnets 242a-242d of actuator 240. In some of these variations, each of the set of magnets 442a-442b may have a rectangular cross-sectional shape and may be positioned adjacent opposite sides of the upper housing 410.

In these instances, the coil 444 may have two first coil sections 444a, 444b having a first cross-sectional and two second coil sections 444c, 444d having a second cross-sectional area larger than the first cross-sectional area. The first coil section 444a may be positioned adjacent to and in the magnetic field of the first magnet 442a, while the first coil section 444b is positioned adjacent to and in the magnetic field of the second magnet 442b. Each of the second coil sections 444c, 444d may connect the first coil section 444a to the first coil section 444b.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

What is claimed is:

1. A coil assembly comprising:
a carrier; and
a flexible printed circuit defining a first coil that is circumferentially disposed around the carrier; the first coil comprising:
a first pair of coil sections, each coil section having a first cross-sectional area; and
a first intermediate coil section bridging the first pair of coil sections, the first intermediate coil section having a second cross-sectional area greater than the first cross-sectional area.

2. The coil assembly of claim 1, wherein the second cross-sectional area is at least twice the first cross-sectional area.

3. The coil assembly of claim 1, wherein the flexible printed circuit defines at least a second coil that is circumferentially disposed around the carrier.

4. The coil assembly of claim 3, wherein:
the first coil comprises a first set of terminals connected to an electrical supply; and
the second coil comprises a second set of terminals connected to the electrical supply, the second set of terminals being electrically isolated from the first set of terminals.

5. The coil assembly of claim 3, wherein the second coil comprises:
a second pair of coil sections, each of the second pair of coil sections having the first cross-sectional area; and
a second intermediate coil section bridging the second pair of coil sections and having the second cross-sectional area.

6. The coil assembly of claim 5, wherein:
the first pair of coil sections is positioned to overlap the second pair of coil sections of the second coil; and
the first intermediate coil section is positioned to overlap the second intermediate coil section.

7. A camera module comprising:
a lens carrier;
a set of lens elements carried by the lens carrier;
a plurality of magnets; and
a coil positioned around the lens carrier and comprising:
a plurality of first coil sections, each first coil section having a first cross-sectional area and positioned adjacent to a corresponding magnet of the plurality of magnets; and
a plurality of second coil sections, each second coil section having a second cross-sectional area greater than the first cross-sectional area and transitioning between a pair of consecutive first coil sections.

8. The camera module of claim 7, wherein the second cross-sectional area is at least twice the first cross-sectional area.

9. The camera module of claim 7, wherein a height of each second coil section is greater than a height of each first coil section.

10. The camera module of claim 9, wherein a thickness of each second coil section is the same as a thickness of each first coil section.

11. The camera module of claim 7, wherein each of the plurality of magnets has a trapezoidal cross-sectional shape.

12. The camera module of claim 7, wherein a height of each second coil section is greater than a height of each of the plurality of magnets.

13. The camera module of claim 7 comprising a flexible printed circuit, wherein the coil is formed from conductive traces of the flexible printed circuit.

14. A camera module comprising:
a lens carrier having a lens module with an optical axis; and
a sensor module comprising an image sensor positioned to receive light from the lens module;
an actuator configured to move the lens carrier relative to the image sensor along the optical axis, the actuator comprising:
a set of magnets; and
a coil comprising:
a set of first coil sections, each having a first cross-sectional area and positioned adjacent to a corresponding magnet of the set of magnets; and
a set of second coil sections, each having a second cross-sectional area greater than the first cross-sectional area.

15. The camera module of claim 14, further comprising an insulating layer positioned between the lens carrier and the coil.

16. The camera module of claim 14, further comprising a driver electrically connected to the coil and configured to drive current through the coil to move the lens carrier relative to the sensor module.

17. The camera module of claim 16, wherein:
the actuator comprises an additional coil; and
the driver is electrically connected to the additional coil to drive current through the additional coil.

18. The camera module of claim 16, wherein the coil comprises a plurality of turns connected to the driver in parallel.

19. The camera module of claim 14, wherein the coil comprises a turns that includes a plurality of turns, each of which encircles the lens carrier.

20. The camera module of claim 14, wherein:
a height of each second coil section is greater than a height of each of the set of magnets; and
a thickness of each first coil section is the same as a thickness of each second coil section.
